(19) United States
(12) Patent Application Publication
(10) Pub. No.: US 2012/0056852 A1
(43) Pub. Date: Mar. 8, 2012

(54) ELECTRONIC APPARATUS AND CONTROL METHOD THEREOF

(76) Inventors: Tsung-Hsi Lee, Tainan City (TW); Shu-Yi Chen, Taipei City (TW)

(21) Appl. No.: 13/118,601

(22) Filed: May 31, 2011

(30) Foreign Application Priority Data
Sep. 8, 2010 (TW) 099130307

(51) Int. Cl. G06F 3/041; G06F 3/043; G06F 3/042

(52) U.S. Cl. 345/175; 345/173; 345/177

(57) ABSTRACT

A method for controlling an electronic apparatus including a touchless interface and a control interface, comprising: detecting a first control action applied to the touchless interface; detecting a second control action applied to the control interface; and controlling the electronic apparatus to perform a corresponding function according to the first control action and the second control action.

### BACKGROUND OF THE INVENTION

1. Field of the Invention

The present application relates to an electronic apparatus control method, an electronic apparatus utilizing the electronic apparatus control method, and particularly relates an electronic apparatus control method controlling a touchless interface and a control interface.

2. Description of the Prior Art

In a modern electronic apparatus, a touch screen is frequently utilized as an interface to control an electronic apparatus. A user can apply other actions to control the electronic apparatus besides select the controlling icons on the touch screen. For example, as shown in FIG. 1, a user can perform a gesture on the touch screen 101 of the electronic apparatus 100 to apply a trace Q, for enlarging a picture or a homepage displayed on the touch screen 101. By this way, a user can conveniently utilize a plurality of gestures to rapidly control the electronic apparatus, rather than search different levels of interfaces to find the function they want.

However, with the development of scientific and technological progress, more and more functions are integrated to the mobile phone (ex: music playing, photographing or navigation). Accordingly, more and more functions can be included in the mobile phone, and the user may more intend to utilize some specific gestures to perform the specific functions. However, few kinds of traces can be applied to a single touch screen. For example, the user may need to utilize a hand to hold the electronic apparatus to prevent it from falling down, and utilizes the other hand to apply a trace to the electronic apparatus, when a trace is desired to be applied to the electronic apparatus. Such control method may cause inconvenience to the user.

### SUMMARY OF THE INVENTION

Therefore, one objective of the present application is to provide an electronic apparatus with a touchless interface and a control interface, and a method to control the electronic apparatus.

One embodiment of the present invention discloses a method for controlling an electronic apparatus including a touchless interface and a control interface, comprising: detecting a first control action applied to the touchless interface; detecting a second control action applied to the control interface; and controlling the electronic apparatus to perform a corresponding function according to the first control action and the second control action.

Another embodiment of the present invention discloses an electronic apparatus comprising: a touchless interface for detecting a first control action; a control interface for detecting a second control action; and a controller performing a corresponding function in the electronic apparatus according to the first control action and the second control action.

Still another method for controlling an electronic apparatus comprising a first interface and a second interface, the method comprising: detecting a first control action applied to the first interface to open an image file; and detecting a second control action applied to the second interface to adjust the image file.

Still another electronic apparatus, comprising: a first interface for detecting a first control action; a second interface for detecting a second action; and a controller for opening an image file of the electronic apparatus according to the first control action, and adjusting the image file according to the second control action.

In view of above-mentioned embodiments, the electronic apparatus can be controlled in different ways, via the touchless interface and the other control interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a prior art electronic apparatus with a touchless interface.

FIG. 2 is an electronic apparatus according to one exemplary embodiment of the present application.

FIG. 3 is a schematic diagram illustrating that the touchless interface and the control interface are at opposite locations, in an electronic apparatus according to one exemplary embodiment of the present application.

FIG. 4 is a schematic diagram illustrating how a user controls the electronic apparatus, in the electronic apparatus shown in FIG. 3.

FIG. 5 to FIG. 8 are schematic diagrams illustrating the operation of combining the control actions applied to the touchless interface and the control interface to control the electronic apparatus.

FIG. 9 is a schematic diagram illustrating the operation of combining two control actions to modify depth of field of an image, according to an exemplary embodiment of the present application.

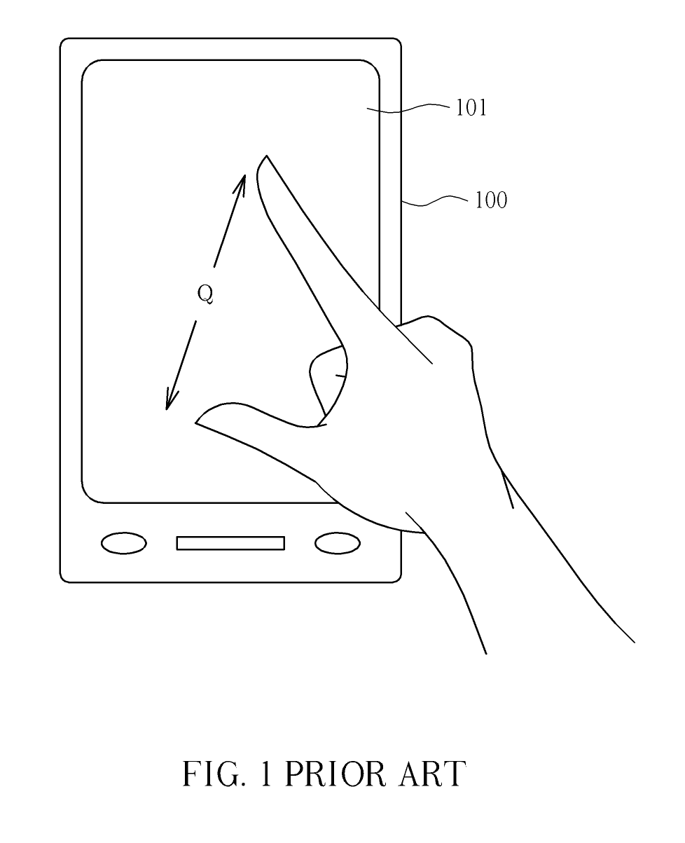

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

In the following embodiment, a mobile phone is utilized to explain the concept of the present application. It should be noted that it does not tend to limit the scope of the present application to the mobile phone. Other electronic such as e-book reader, plate computer and other electronic apparatuses not mentioned here should be included in the scope of the present application.

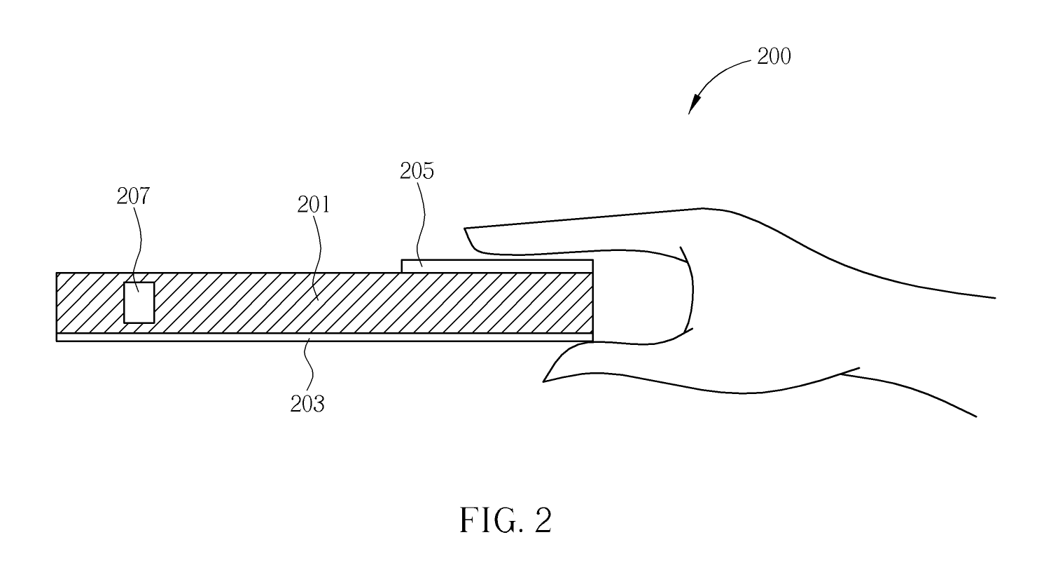

FIG. 2 is an electronic apparatus according to one exemplary embodiment of the present application. As shown in FIG. 2, the electronic apparatus 200 includes an electronic apparatus body 201, a touchless interface 203 and a control interface 205. The touchless interface 203 comprises a plurality of touchless sensors, such as optical sensors or ultrasonic sensors. The electronic apparatus body 201 can comprise a controller 207 such as a micro processor. Such controller can be independent from a main processor of the electronic apparatus 200. The controller 207 can control the electronic apparatus to perform a corresponding function according to a first control action applied to the touchless interface 203 and a second control action applied to the control interface 205. The corresponding function can be initially set according to the firmware in the electronic apparatus or be set according to a user's different requirements. For the touchless interface 203, the first control action can be a movement of an object, a touching action or a pressing action, wherein the object for example can be a pointer or a user finger. The control interface 205 can be a touch control interface (e.g., touch panel), a touchless control interface, or other traditional user interfaces such as a trackball or a keyboard. Similarly, the second control action can be movement of an object, a touching action or a pressing action, wherein the object for example can be a pointer or a user finger. The movement for example can be at least one of the followings: a substantially linear motion, a substantially circular motion, a substantially curve motion, a tapping motion, a substantially circular motion in combination with a linear motion, a motion relatively close to or far from the control interface or the touchless interface. As a preferable embodiment shown in FIG. 2, the touchless interface 203 and the control interface 205 are respectively located at the front side and the rear side of the electronic apparatus 200. That is, the locations of the touchless interface 203 and the control interface 205 are opposite. In this situation, the user can hold the electronic apparatus 200 with one hand and use the fingers of the same hand to perform control actions to the touchless interface 203 and the control interface 205. Other detail operations will be described as below.

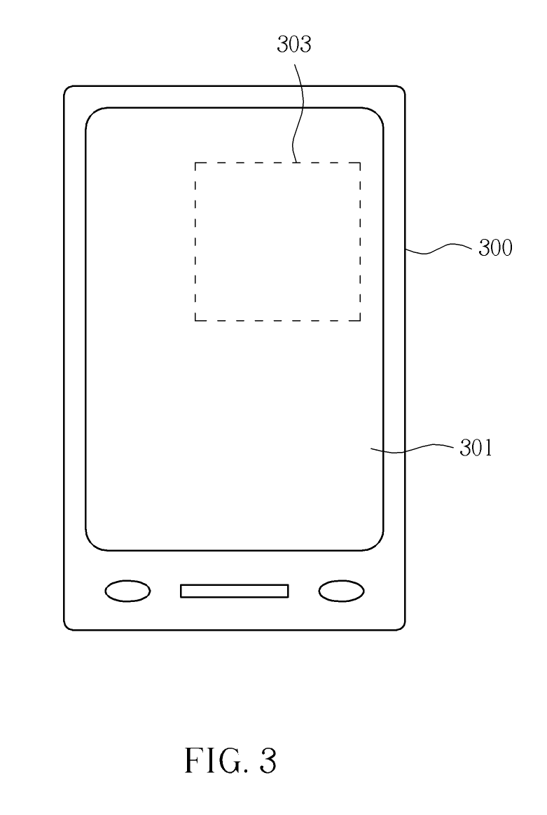

FIG. 3 is a schematic diagram illustrating that the touchless interface and the control interface are at opposite locations, in an electronic apparatus according to one exemplary embodiment of the present application. In view of FIG. 3, it is apparent that the touchless interface 301 and the control interface 303 are respectively located at the front side and the rear side of the electronic apparatus 300, that is, at opposite locations. It should be noted that the present application is not limited that the touchless interface and the control interface should be located at opposite locations. The touchless interface and the control interface can be configured at different sides of the electronic apparatus, not limited to opposite sides. For example, the control interface 303 can be provided next to the touchless interface 301. In addition, the touchless interface 301 and the control interface 303 can be formed in various sizes.

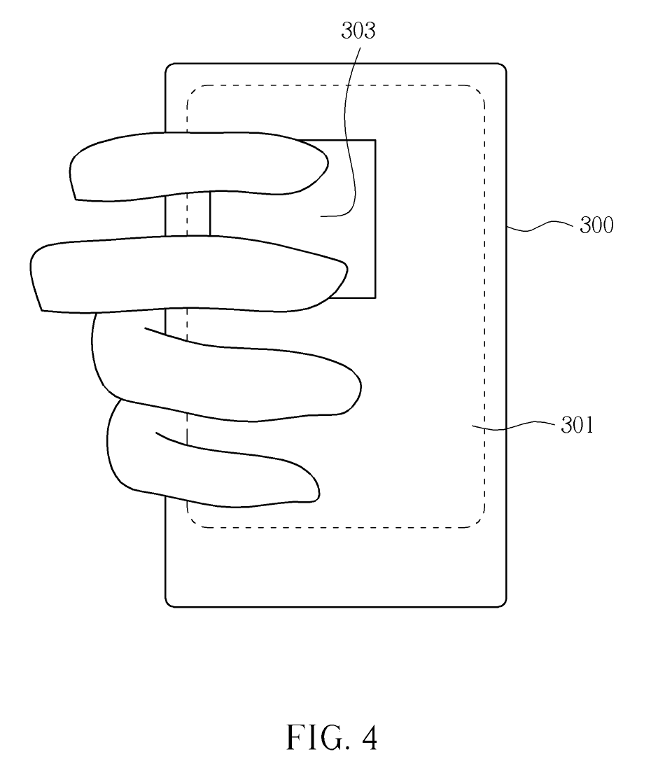

FIG. 4 is a schematic diagram illustrating how a user controls the electronic apparatus, in the electronic apparatus shown in FIG. 3. As shown in FIG. 4, the user can apply control actions to the touchless interface 301 at the front and the control interface 303 at the rear side to perform a control action to control the electronic apparatus 300, while holding the electronic apparatus.

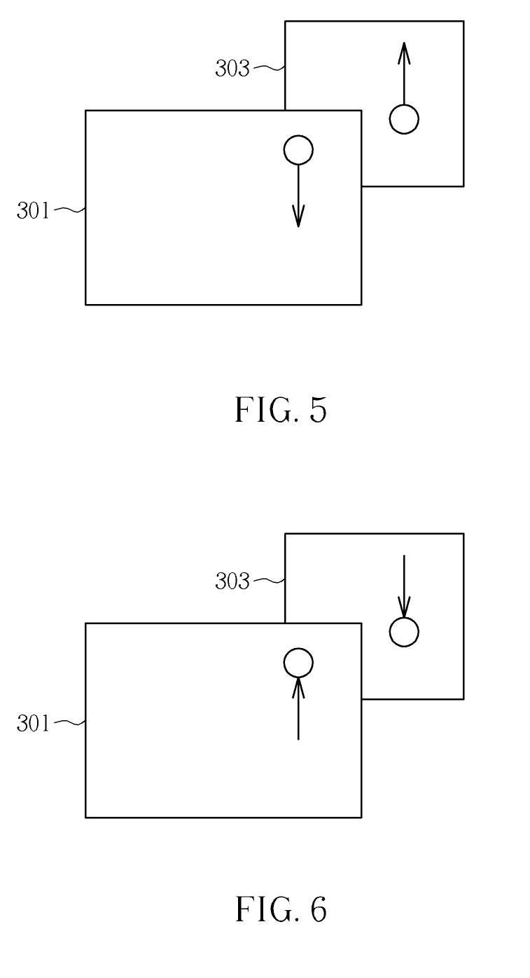

FIG. 5-FIG. 8 are schematic diagrams illustrating the operation of combining the control actions applied to the touchless interface and the control interface to control the electronic apparatus. It should be noted that although a movement of an object is utilized as an example for control actions in FIG. 5-FIG. 8, it does not mean to limit the scope of the present application. Other control actions such as pressing, touching can also be utilized in the present application. Moreover, the relation between the control action and corresponding functions of the electronic apparatus is not limited to what is shown in FIGS. 5-8.

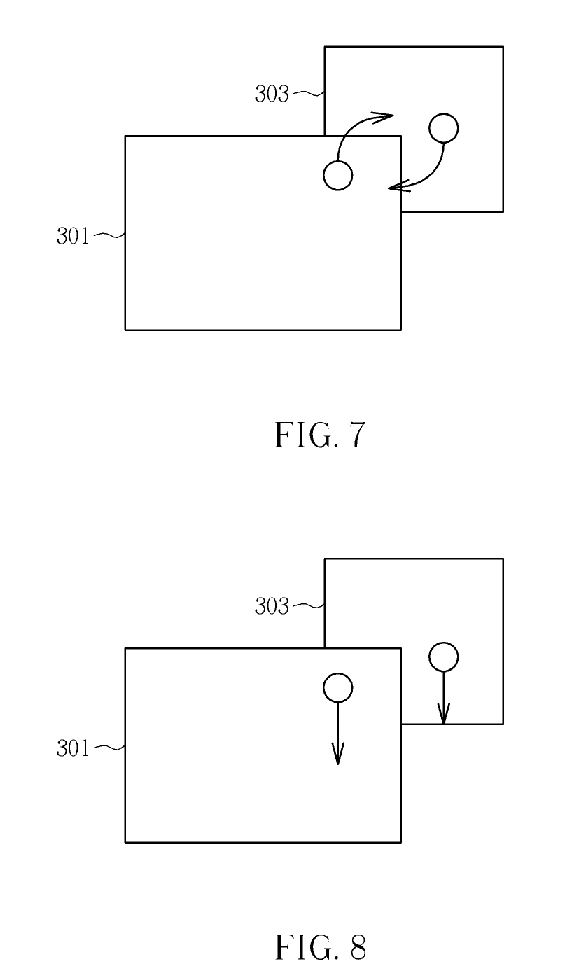

In FIG. 5, the control action on the touchless interface 301 and the control action on the control interface 303 are two traces away from each other, and the corresponding function is enlarging an image displayed on either or both of the interfaces. In FIG. 6, the control action on the touchless interface 301 and the control action on the control interface 303 are two traces toward each other, and the corresponding function is diminishing an image displayed on either or both of the interfaces. In FIG. 7, the control action on the touchless interface 301 and the control action on the control interface 303 are curved traces (e.g., clockwise trace or counterclockwise trace), and the corresponding function is rotating the image displayed on either or both of the interfaces. In FIG. 8 the control action on the touchless interface 301 and the control action on the control interface 303 are traces in the same directions, and the corresponding function is displaying the trace (e.g., drawing function) on either or both of the interfaces.

In one embodiment, the electronic apparatus only performs corresponding operation according to the control action on the touchless interface 301 and the control interface 303. In another embodiment, the electronic apparatus only performs the corresponding function when the first control action and the second control action are substantially simultaneously performed.

In view of abovementioned embodiments, an electronic apparatus control method, a electronic apparatus control method, which comprises: detecting a first control action applied to the touchless interface; detecting a second control action applied to the control interface; and combining the first control action and the second control action to control the electronic apparatus to perform a corresponding function. Other detail steps can be obtained according to above-mentioned embodiments, thus it is omitted for brevity here. Furthermore, such electronic apparatus control method can be executed via computer readable recording media such as a hard disk or an optical disc.

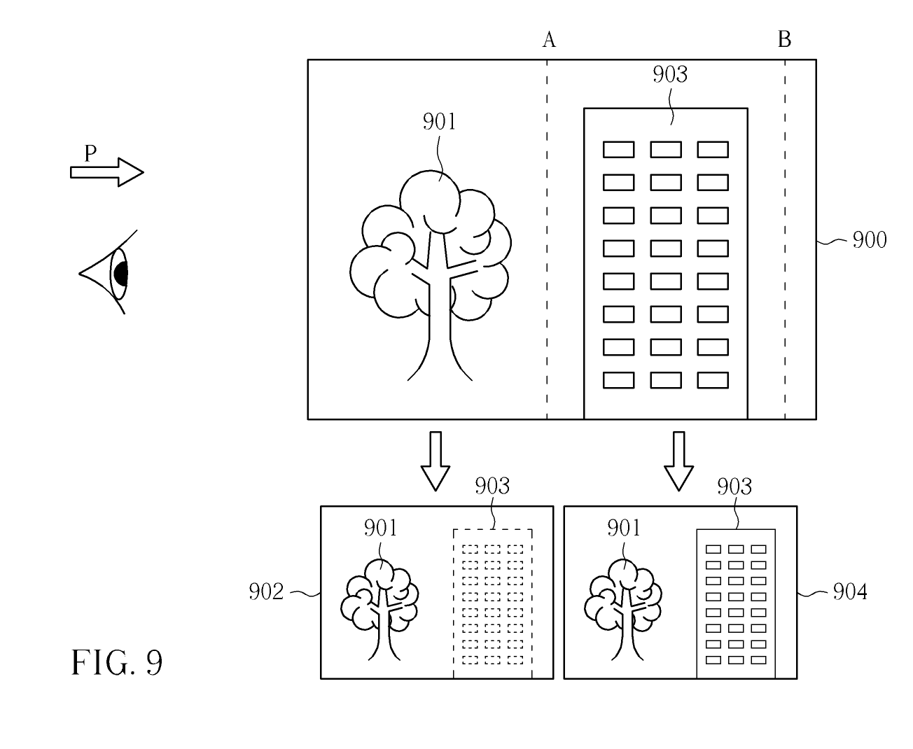

FIG. 9 is a schematic diagram illustrating the operation of combining two control actions to adjust depth of field of an image, according to an exemplary embodiment of the present application. In this embodiment, a control action is applied to the first interface to open a image, and then the image is adjusted by a control action applied to a second interface. In one preferable embodiment, either or both of the first interface and the second interface can be a touch interface or a touchless interface. In this exemplary embodiment, an operation of adjusting depth of field of the image file is taken for example. However, the operation of adjusting other parameters of the image should also be included in the scope of the present application. That is, the image can be adjusted in accordance with the control action applied to either the first interface or the second interface. The step of modifying depth of field of the image can be shown as in FIG. 9, which modifies the image to make some objects more clear. The image 900 in FIG. 9 includes a tree closer to a user, and a building 903 farther from the user. If the depth of field is short and can not include the building 903 (ex; the depth of field is at the A location), the user will see an image such as the image 902, which has a clear tree 901 since it is inside the depth of field, but a indistinct building 903 since it is outside the depth of field. If the depth of field is long enough to can include the building 903 (ex; the depth of field is at B location), the user will see an image such as the still image 904, which has clear images both for the tree 901 and the building 903. Notably, according to the present invention, the two control action is not limited to adjust the depth of field of the image, it can adjust other parameters as well, such as viewing angle of the image. In addition, according to the present invention, the image can comprise a static image (e.g., a still image) or a dynamic image (e.g., video).

In view of above-mentioned embodiments, the electronic apparatus can be controlled in convenience and in different ways, via the touchless interface and the other control interface.

Those skilled in the art will readily observe that numerous modifications and alterations of the device and method may be made while retaining the teachings of the invention.

What is claimed is:

1. A method for controlling an electronic apparatus including a touchless interface and a control interface, comprising:
detecting a first control action applied to the touchless interface;
detecting a second control action applied to the control interface; and
controlling the electronic apparatus to perform a corresponding function according to the first control action and the second control action.

2. The method of claim 1, wherein the touchless interface comprises an optical sensors and/or an ultrasonic sensor.

3. The method of claim 1, wherein the control interface is a touch control interface.

4. The method of claim 3, wherein the first control action and/or the second control action are one of the followings: a movement of an object, a touching action, or a pressing action.

5. The method of claim 4, wherein the movement comprises at least one of the followings: a substantially linear motion, a substantially circular motion, a substantially curve motion, a tapping motion, a substantially circular motion in combination with a linear motion, a motion relatively close to or far from one of the control interface and the touchless interface.

6. The method of claim 1, wherein the touchless interface and the control interface are configured at different sides of the electronic apparatus.

7. The method of claim 6, wherein the touchless interface and the control interface are configured at a front and a rear side of the electronic apparatus respectively.

8. An electronic apparatus, comprising:
a touchless interface for detecting a first control action;
a control interface for detecting a second control action; and
a controller performing a corresponding function in the electronic apparatus according to the first control action and the second control action.

9. The electronic apparatus of claim 8, wherein the touchless interface comprises an optical sensors and/or an ultrasonic sensor.

10. The electronic apparatus of claim 8, wherein the control interface is a touch control interface.

11. The electronic apparatus of claim 8, wherein the first control action and/or the second control action comprise one of the followings: a movement of an object, a touching action and pressing action.

12. The electronic apparatus of claim 11, wherein the movement comprises at least one of the followings: a substantially linear motion, a substantially circular motion, a substantially curve motion, a tapping motion, a substantially circular motion in combination with a linear motion, a motion relatively close to or far from one of the control interface and the touchless interface.

13. The electronic apparatus of claim 8, wherein the touchless interface and the control interface are configured at different sides of the electronic apparatus.

14. The electronic apparatus of claim 13, wherein the touchless interface and the control interface are configured at a front and a rear side of the electronic apparatus respectively.

15. A method for controlling an electronic apparatus comprising a first interface and a second interface, the method comprising:
detecting a first control action applied to the first interface to open an image file; and
detecting a second control action applied to the second interface to adjust the image file.

16. The method of claim 15, wherein the first interface and/or the second interface is a touchless interface.

17. The method of claim 15, wherein the step of adjusting the image file comprises: at lest one of the following steps: modifying depth of field of the image file, and adjusting viewing angle of the image file.

18. The method of claim 15, wherein the image file comprises at least one of: a static image file and a dynamic image file.

19. An electronic apparatus, comprising:
a first interface for detecting a first control action;
a second interface for detecting a second action; and
a controller for opening an image file of the electronic apparatus according to the first control action, and adjusting the image file according to the second control action.

20. The electronic apparatus of claim 19, wherein the first interface and/or the second interface is a touchless interface.

21. The electronic apparatus of claim 19, wherein the controller performs at least one of the following steps: adjusting depth of field of the image file, and adjusting viewing angle of the image file.

22. The method of claim 19, wherein the image file comprises at least one of: a static image file and dynamic image file.
